(19) United States
(12) Patent Application Publication
(10) Pub. No.: US 2005/0237566 A1
(43) Pub. Date: Oct. 27, 2005

(54) Image supplying apparatus, image storing apparatus, automatic storing system, and image storing method

(75) Inventors: Kenji Sakuda, Nagano (JP); Hideki Morozumi, Nagano (JP); Yoshinao Kitahara, Nagano (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/050,444

(22) Filed: Feb. 4, 2005

(30) Foreign Application Priority Data
Feb. 4, 2004 (JP) P2004-028194

(51) Int. Cl. G06F 15/00

(52) U.S. Cl. 358/1.15

(57) ABSTRACT

A monitor monitors whether or not an image output apparatus adapted to receive an image data file and to store the image data file is communicable with the communicator. A communication connector connects the communicator to the image storing apparatus when the monitor determines that the communicator is communicable with the communicator. A saving instructor causes the image storing apparatus to initiate saving operation of the image data file immediately after the communicator is connected to the image storing apparatus.

### BACKGROUND OF THE INVENTION

The present invention relates to an image supplying apparatus, an image storing apparatus, an automatic storing system, and an image storing method, which are for storing image data files stored in the image supplying apparatus into the image storing apparatus.

Japanese Patent Publication No. 2003-259274A discloses a printing system where a digital camera, which is a USB storage class device, is connected directly to a printer, which is an USB host, by a USB (Universal Serial Bus). In this system, the camera generates, in the form of a file, a print status request, a print request, or a print abort request to the printer in accordance with operation of a button of the camera, and writes the file into internal memory of the camera. After having established a communication connection with the camera, the printer periodically checks the internal memory of the camera at a high-speed rate. When having found a requested file, the printer reads the file and executes the requested operation.

In the above-described printing system, an image file stored in the camera is transmitted to the printer as a result of a button of the camera being actuated, and the image is printed.

Incidentally, by application of this related-art printing system, an image data file stored in the camera can conceivably be transmitted and saved to an image storing apparatus.

However, when consideration is given to a system which saves an image data file stored in a camera into an image storing apparatus by application of such an image printing system, the user must actuate the button of the camera to thus generate a status request or a saving request and cause the image storing apparatus to receive these requests.

Therefore, the image file stored in the camera cannot be saved in the image storing apparatus by mere application of such a related-art printing system unless the user performs operation for acquiring software or setting storage conditions.

A round of operations required for transmitting the image file from the camera to the image storing apparatus cannot be said to be simple. Further, these operations must be performed every time an attempt is made to transmit the image file. For this reason, some users feel burdened by the round of operations required to transmit an image file.

### SUMMARY OF THE INVENTION

It is therefore an object of the invention to provide an image supplying apparatus, an image storing apparatus, an automatic storing system, and an image storing method, which do not require a user to perform complicated operation every time an image data file stored in the image supplying apparatus is stored in the image storing apparatus.

In order to achieve the above object, according to the invention, the present invention provides an image supplying apparatus comprising:
a communicator;
a monitor, which monitors whether or not an image output apparatus adapted to receive an image data file and to store the image data file is communicable with the communicator;
a communication connector, which connects the communicator to the image storing apparatus when the monitor determines that the communicator is communicable with the communicator; and
a saving instructor, which causes the image storing apparatus to initiate saving operation of the image data file immediately after the communicator is connected to the image storing apparatus.

By this configuration, the communicator is automatically connected to the image storing apparatus. Subsequently, save of the image data file of the image supplying apparatus is immediately commenced. Therefore, the user does not need to perform complicated operation for causing the image supplying apparatus or the image storing apparatus to save the image data file. Consequently, the user is not required to perform complicated operation, which would otherwise be required every time an image data file of the image supplying apparatus is saved in the image storing apparatus.

Preferably, the saving instructor causes the image storing apparatus to store only image data files having no saving log, as determined on the basis of a log pertaining to storage of an image data file into the image storing apparatus.

By this configuration, the image data files having already been stored in the image storing apparatus are not transmitted to the image storing apparatus. Consequently, repetitive storage of the same image data file into the image storing apparatus can be prevented.

According to the invention, there is also provided an image storing apparatus comprising:
a communicator;
an acquirer, which acquires an image data file from an image supplying apparatus by way of the communicator immediately after the image supplying apparatus adapted to transmit an image data file has become communicable with the communicator;
a storage; and
a saver for saving the acquired image data file into the storage.

By this configuration, save of the image data file of the image supplying apparatus is immediately initiated after connection with the image supplying apparatus has been established. Consequently, the user does not have to perform complicated operation for causing the image storing apparatus or the image supplying apparatus to store the image data file. Therefore, the user is not required to perform complicated operation, which would otherwise be required every time the image data file of the image supplying apparatus is stored in the image storing apparatus.

Preferably, the saver saves the acquired image data files into the storage after having classified the files according to the type of an image.

By this configuration, the image data files are saved in the storage after having been classified according to the type of an image. Consequently, despite not having performed saving operation by himself/herself, the user can efficiently find a target image data file from among a plurality of image data files stored in the image storing apparatus according to the categories.

More preferably, the saver determines the type of an image of the acquired image data file on the basis of at least one of a criterion for determining an imaging date, a criterion for determining that an image is blurred, a criterion for determining that an image is a panoramic image, a criterion for determining an image is one of successively-captured images, a criterion for determining the type of a subject, and a criterion for determining a recording mode.

By this configuration, the image data files can be classified on the basis of at least one of the criterion for determining an imaging date, the criterion for determining that an image is blurred, the criterion for determining that an image is a panoramic image, the criterion for determining that an image is one of successively-captured images, the criterion for determining the type of a subject, and the criterion for determining a recording mode.

Preferably, the saver saves the acquired image data file into a different folder of the storage according to a determination result of the type of the image.

By this configuration, the image data files can be saved in the storage while being classified in folders provided for respective types of images.

Preferably, after having saved the acquired image data file into the storage, the saver saves in the storage map link data which associate information about a location of the storage where the image data file is stored with information about a location where an image of the image data file has been captured.

By this configuration, the information about the location where the image of the image data file stored in the storage has been captured is stored in the map link data. Consequently, despite not having performed saving operation by himself/herself, the user can efficiently retrieve the target image data file from among the plurality of image data files stored in the image storing apparatus.

According to the invention, there is also provided an automatic storing system having the above image supplying apparatus and the above image storing apparatus.

By this configuration, the image supplying apparatus and the image storing apparatus are automatically connected together, after which save of the image data files of the image supplying apparatus into the image storing apparatus is commenced. Therefore, the user does not need to perform complicated operation for causing the image supplying apparatus or the image storing apparatus to store the image data file. Consequently, the user is not required to perform complicated saving operation, which would otherwise be required every time the image data file of the image supplying apparatus is saved in the image storing apparatus.

According to the present invention, there is also provided an image storing method, comprising:
monitoring whether or not an image supplying apparatus adapted to output an image data file is communicable with an image storing apparatus adapted to receive and store the image data file;
connecting the image supplying apparatus to the image storing apparatus when the image supplying apparatus and the image storing apparatus become communicable with each other; and
transmitting the image data file from the image supplying apparatus to the image storing apparatus immediately after the connection between the image supplying apparatus and the image storing apparatus is established, in order to save the image data file in the image storing apparatus.

By this configuration, the image supplying apparatus and the image storing apparatus are automatically connected together, after which save of the image data files of the image supplying apparatus into the image storing apparatus is immediately commenced. Therefore, the user does not need to perform complicated operation for causing the image supplying apparatus or the image storing apparatus to store the image data file. Consequently, the user does not have to perform complicated saving operation, which would otherwise be required every time the image data file of the image supplying apparatus is saved in the image storing apparatus.

### BRIEF DESCRIPTION OF THE DRAWINGS

In the accompanying drawings:

FIG. 1 is a block diagram showing an automatic storing system according to a first embodiment of the present invention;

FIG. 2 is a block diagram showing the hardware configuration of a DSC shown in FIG. 1;

FIG. 3 is a view showing stored contents of a flash memory shown in FIG. 2;

FIG. 4 is a view showing stored contents of a removable memory shown in FIG. 2;

FIG. 5 is a block diagram showing the hardware configuration of a wireless server shown in FIG. 1;

FIG. 6 is a view showing stored contents of a memory shown in FIG. 5;

FIG. 7 is a view showing a stacked structure of a communication protocol for automatic saving realized by the automatic storing system shown in FIG. 1;

FIG. 8 is a view showing an automatic saving sequence to be executed between the DSC and the wireless server, both of which are shown in FIG. 1;

FIG. 9 is a view showing an example start request generated by a copy client;

FIG. 10 is a view showing another example start request generated by the copy client;

FIG. 11 is a view showing stored contents of memory of a wireless server provided in an automatic storing system according to a second embodiment of the present invention;

FIG. 12 is a view showing a stacked structure of a communication protocol for automatic saving realized by the automatic storing system of the second embodiment;

FIG. 13 is a flowchart showing an example operation of a saving processor according to the second embodiment;

FIG. 14 is a view showing stored contents of a storage device of a wireless server provided in an automatic storing system according to a third embodiment of the present invention;

FIG. 15 is a view showing stored contents of a memory of the wireless server provided in the automatic storing system according to the third embodiment of the present invention;

FIG. 16 is a view showing a stacked structure of a communication protocol for automatic saving realized by the automatic storing system of the third embodiment; and

FIG. 17 is a flowchart showing an example saving operation of a saving processor according to the third embodiment.

### DETAILED DESCRIPTION OF THE INVENTION

An image supplying apparatus, an image storing system, an automatic storing system, and an image storing method, all pertaining to embodiments of the present invention, will be described hereunder by reference to the accompanying drawings. The image supplying apparatus will be described by taking a digital still camera as an example. The image storing apparatus will be described by taking a wireless server as an example. An image storing method will be described in connection with the automatic storing system.

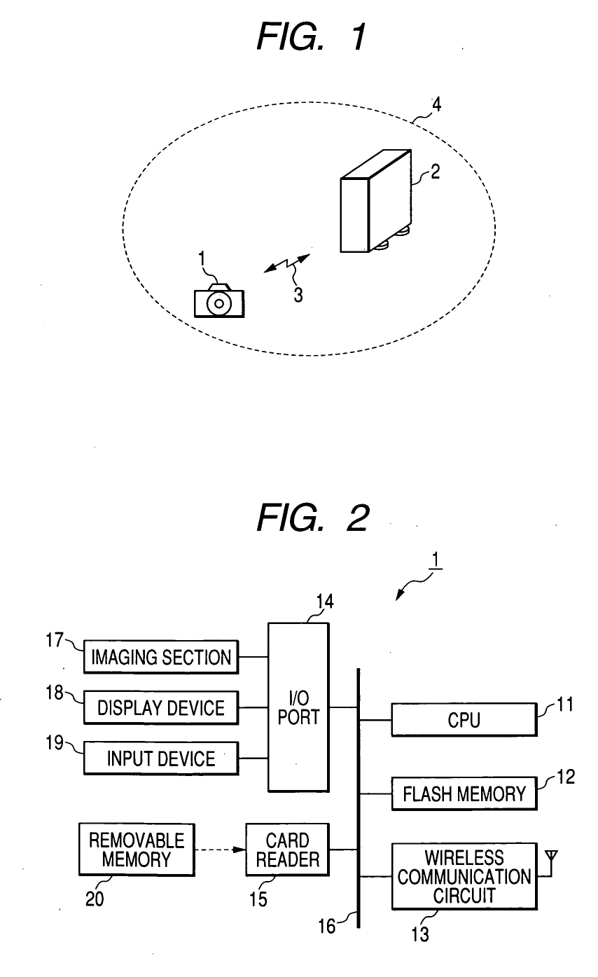

FIG. 1 is a block diagram showing an automatic storing system according to a first embodiment of the present invention. The automatic storing system comprises a digital still camera (DSC) 1 which is to serve as an image supplying apparatus, and a wireless server 2 which is to serve as an image output apparatus. The DSC 1 and the wireless server 2 are connected together by a wireless network 3 realized by wireless communication.

The wireless network 3 is, for example, a wireless network 3 based on IEEE (Institute of Electrical and Electronic Engineers) 802.11 or a close-zone wireless communication network such as Bluetooth (trademark). Moreover, unlike the wireless network based on IEEE or the short-zone wireless communication network, the wireless network 3 may use infrared rays rather than radio waves. The wireless network 3 may have an access restriction function involving preliminary registration, such as a MAC (Media Access Control) address, or an anti-tapping function using WEP (Wired Equivalent Privacy). Incidentally, the wireless network 3 is realized as a result of presence of the DSC 1 in a wireless connection zone 4 of the wireless server 2. Put another way, the network is realized as a result of the wireless server 2 being present within the wireless connection zone 4 of the DSC 1. More specifically, communication between the DSC 1 and the wireless server 2 becomes possible as a result of either the DSC 1 entering the wireless connection zone 4 of the wireless server 2 or the wireless server 2 entering the wireless connection zone of the DSC 1.

FIG. 2 is a block diagram showing the hardware configuration of the DSC 1 in FIG. 1. The DSC 1 comprises a CPU (Central Processing Unit) 11, which executes a program; a flash memory 12; a wireless communication circuit 13 which is to serve as a communicator and is connected to the wireless network 3; an I/O (input/Output) port 14; a card reader 15; and a bus 16 for interconnecting these elements. An imaging section 17 which produces image data by imaging action, a display device 18 for displaying various data or images, and an input device 19 for producing input data in accordance with an operation are connected to the I/O port 14. A removable memory 20 which is formed from a semiconductor memory or the like is removably inserted into the card reader 15.

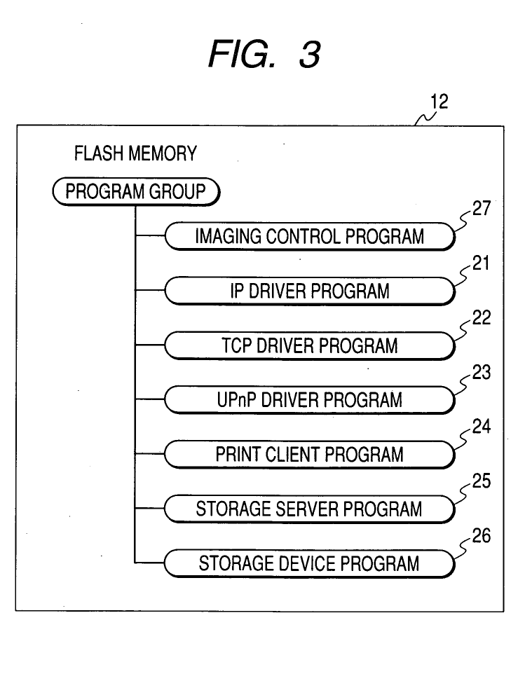

FIG. 3 is a view showing stored contents of the flash memory 12 shown in FIG. 2. A program group is stored in the flash memory 12. The program group of the flash memory 12 includes an imaging control program 27, an IP (Internet Protocol) driver program 21, a TCP (Transmission Control Protocol) driver program 22, a file transfer program 23, a copy client program 24, a storage server program 25, and a storage device program 26.

The imaging control program 27 is executed by the CPU 11, thereby embodying an imaging controller. This imaging controller controls the imaging section 17. The imaging controller stores the image data captured by the imaging section 17 in the removable memory 20 as image data files of a JPEG (Joint Photographic Expert Group) scheme, an EXIF (Exchangeable Image File Format) scheme, or the like.

The IP driver program 21 is executed by the CPU 11, thereby embodying an IP driver. The Internet protocol uses an IP address. This IP address is an address uniquely assigned within at least the wireless network 3 on a per-device basis. The IP address also includes a broadcast address. The IP driver uses the IP address to exchange transmission with another IP driver.

The TCP driver program 22 is executed by the CPU 11, thereby implementing a TCP driver. This TCP driver ensures connection with another TCP driver and manages a communication channel.

The file transfer program 23 is executed by the CPU 11, thereby realizing a file transferee. The file transferer exchanges a file with another file transferer.

The copy client program 24 is executed by the CPU 11, thereby realizing a copy client. The copy client exchanges a request or response pertaining to control of a progress in printing operation or to printing operation.

The storage server program 25 is executed by the CPU 11, thereby realizing a storage server. The storage server exchanges a request or response pertaining to a saving operation.

The storage device program 26 is executed by the CPU 11, thereby realizing a storage device. The storage server device performs operation for inputting or outputting data into or from the removable memory 20.

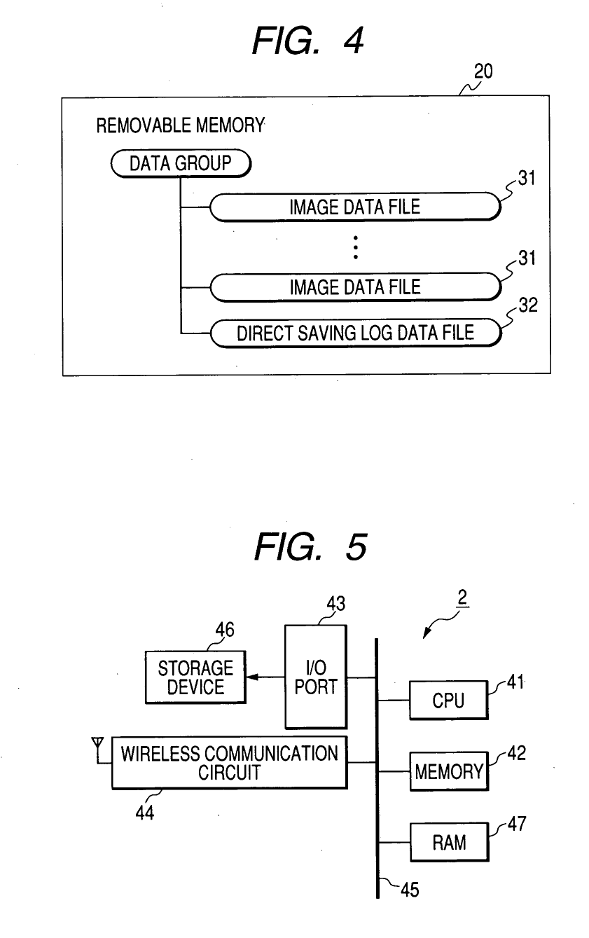

FIG. 4 is a view showing stored contents of the removable memory 20 shown in FIG. 2. A data group is stored in the removable memory 20. The data group in the removable memory 20 includes image data files 31. Each of the image data files 31 stores image data pertaining to one stationary image. The image data generated by the imaging section 17 are included in the image data file 31 of the removable memory 20. Each of the image data files 31 has a file name and a file ID (address), which are different from those of the other image data files.

The data group of the removable memory 20 also includes a direct saving log data file 32 employed as log data. The direct saving log data file 32 is a file which records a direct saving log (saving log) pertaining to the image data file 31 stored in the removable memory 20. Specifically, file information (a file name, a file ID, or the like) about the image data files 31 which have ever been automatically stored is stored in the direct saving log data file 32.

FIG. 5 is a block diagram showing the hardware configuration of the wireless server 2 shown in FIG. 1. The wireless server 2 comprises a CPU 41, memory 42 into which programs are stored previously, an I/O port 43, a wireless communication circuit 44 which is to serve as a communicator to be connected to the wireless network 3, a bus 45 for interconnecting these elements, and RAM (Random Access Memory) 47 for temporary storage. A storage device 46 which is to serve as a storage is connected to the I/O port 43. The storage device 46 is a nonvolatile recording medium; e.g., a hard disk device or an optical disk device. The storage device can store a much larger volume of data than can the removable memory 20 of the DSC 1. In contrast with the case where data are temporarily stored in the RAM 47, an image data file is stored in the storage device 46 for saving purpose.

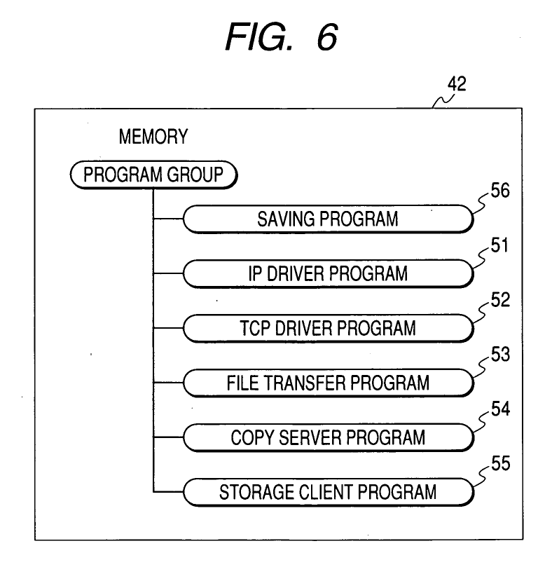

FIG. 6 is a view showing stored contents of the memory 42 shown in FIG. 5. A program group is stored in the memory 42. The program group of the memory 42 includes a saving program 56, an IP driver program 51, a TCP driver program 52, a file transfer program 53, a copy server program 54, and a storage client program 55.

The saving program 56 is executed by the CPU 41, thereby realizing a saver. The saver stores the files stored in the RAM 47 into the storage device 46.

The IP driver program 51 is executed by the CPU 41, thereby realizing an IP driver. The TCP driver 52 is executed by the CPU 41, thereby embodying a TCP driver. The file transfer program 53 is executed by the CPU 41, thereby realizing a file transferee.

The copy server program 54 is executed by the CPU 41, thereby realizing a copy server. The copy server exchanges with a copy client a request or response pertaining to control of progress in printing operation or to printing operation.

The storage client program 55 is executed by the CPU 41, thereby realizing a storage client. The storage client exchanges with a storage server a request or response pertaining to a saving operation.

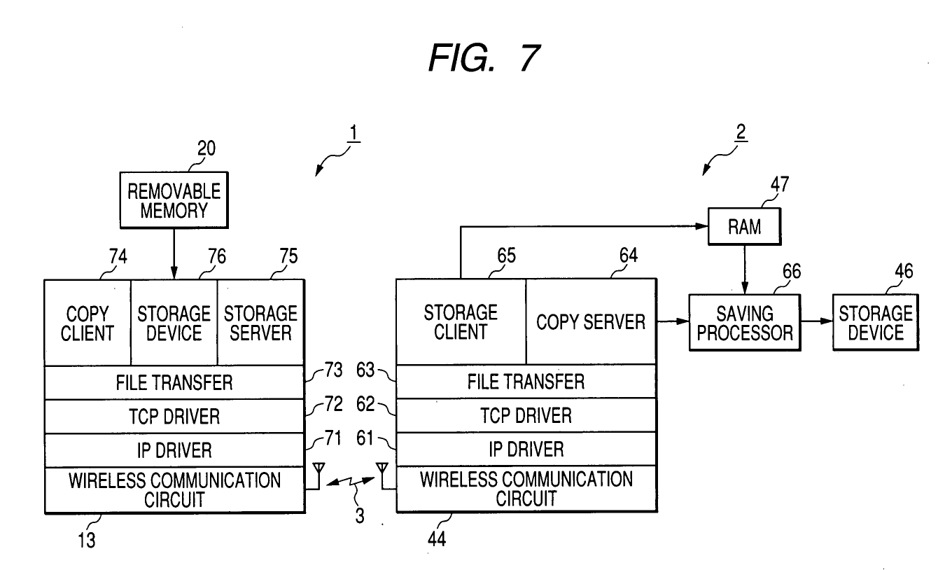

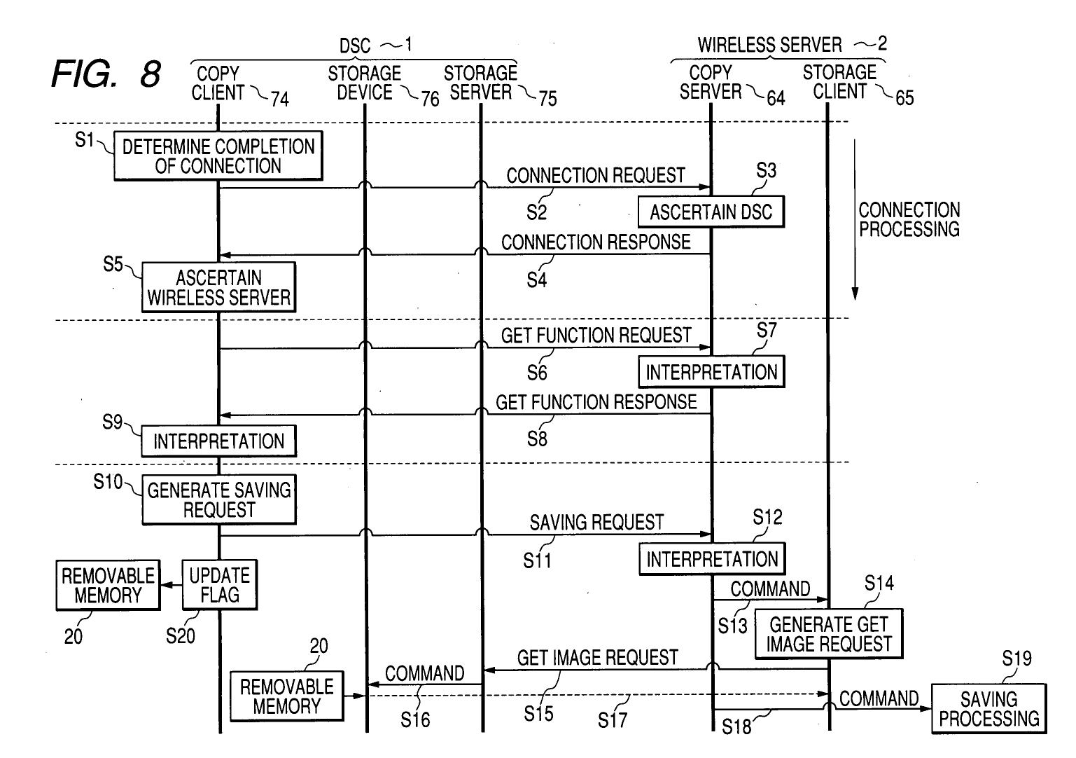

Next, operation of the automatic storing system having the above-described configuration will be described. FIG. 7 is a view showing a stacked structure of a communication protocol for use in automatic saving realized by the automatic storing system shown in FIG. 1. FIG. 8 is a view showing an automatic saving operation sequence performed between the DSC 1 and the wireless server 2.

In the wireless server 2, various programs are executed at start-up. An IP driver 61, a TCP driver 62, and a file transferer 63 are ranked higher than the wireless communication circuit 44. A copy server 64, and a storage client 65 which is to serve as an acquirer are ranked higher than the file transferer 63. Moreover, a saving processor 66 which is to serve as a saver is realized in the wireless server 2.

No DHCP (Dynamic Host Configuration Protocol) server which assigns an IP address is present in the wireless network 3. Therefore, even when having sent a request for adding an IP address to the wireless network 3, the IP driver 61 of the wireless server 2 cannot acquire an IP address of its own as a response.

For this reason, a timeout arises in the DHCP server awaiting acquisition of an IP address. When the timeout has arisen, the IP driver 61 of the wireless server 2 selects one from a plurality of previously-assigned IP addresses. The IP driver 61 of the wireless server 2 causes the wireless communication circuit 44 to transmit a request for ascertaining whether or not the thus-selected IP address is being used. A broadcast address is specified as a destination of the request data.

For instance, in a case where the wireless server 2 has been started up prior to the DSC 1, the wireless communication circuit 44 of the wireless server 2 does not receive any response data even when a predetermined time has lapsed since transmission of the request data. After a timeout has arisen, the IP driver 61 of the wireless server 2 specifies the selected IP address as its own IP address. Thus, the wireless server 2 is started up. Subsequently, the wireless server 2 periodically attempts to detect another piece of connectable equipment (DSC 1).

In the meantime, when the DSC 1 has been started up and various programs are executed, an IP driver 71 which is to serve as a monitor, a TCP driver 72, and a file transferer 73 which is to serve as a communication connector are embodied in levels which are higher than the wireless communication circuit 13 in the DSC 1. A copy client 74 which is to be serve as a saving instructor, a storage server 75, and a storage device 76 are embodied at levels which are higher than the file transferer 73.

When the power of the DSC 1 is turned on, operation for acquiring an IP address is initiated. However, a timeout also arises in the DSC 1 awaiting acquisition of the IP address of the DHCP server. Hence, the IP driver 71 of the DSC 1 selects one from the plurality of previously-assigned IP addresses, and transmits to the wireless communication circuit 13 request data to be used for ascertaining whether or not the selected IP address is being used.

When the DSC 1 is present within the wireless connection zone 4 of the wireless server 2, the request data transmitted to the wireless network 3 are received by the wireless communication circuit 44 of the wireless server 2. The wireless communication circuit 44 of the wireless server 2 outputs the request data to the IP driver 61 of the wireless server 2. The IP driver 61 of the wireless server 2 compares its own IP address with the IP address included in the request data. When a match is found, the IP driver 61 transmits the response data to the wireless communication circuit 44. The response data transmitted to the wireless network 3 are received by the wireless communication circuit 13 of the DSC 1.

When having received the response data, the wireless communication circuit 13 of the DSC 1 outputs the response data to the IP driver 71 of the DSC 1. When a timeout has arisen without the IP driver 71 of the DSC 1 receiving the response data, the IP driver 71 designates the selected IP address as its own IP address.

In the meantime, when having received the response data, the IP driver 71 again selects another IP address from the plurality of previously-assigned IP addresses, and transmits to the wireless communication circuit 13 request data to be used for ascertaining whether or not the newly selected IP address is being used.

Subsequently, the IP driver 71 of the DSC 1 repeats the operation for re-selecting an IP and operation for ascertaining whether or not the thus-selected IP address is being used, until an unoccupied IP address is found. Even when the wireless server 2 and the DSC 1 separately perform operation for selecting an IP address, occurrence of an overlap of a single IP address in the wireless network 3 can be prevented. When the DSC 1 does not exist within the wireless connection zone 4 of the wireless server 2 at start-up and then enters the wireless connection zone 4 of the wireless server 2, the same IP address may be assigned to the DSC 1 and the wireless server 2. When the DSC 1 and the wireless server 2 are assigned the same IP address, any one of the IP addresses is changed to any other IP address during operation for connecting the DSC 1 to the wireless server 2 or when the DSC 1 is moved to the wireless connection zone 4.

The IP address of the DSC 1 and that of the wireless server 2 are determined as mentioned above. When the IP addresses have been determined, the file transferer 73 of the DSC 1 searches for another piece of connectable equipment. When another piece of connectable equipment is not found, the file transferer 73 of the DSC 1 periodically or continuously searches for such equipment. At this time, the file transferer 73 of the DSC 1 broadcasts a predetermined request within the network. On the basis of a response to the thus-broadcasted request, the file transferer 73 of the DSC 1 detects another piece of connectable equipment. Therefore, when the DSC 1 is present within the wireless connection zone 4 of the wireless server 2, the file transferer 63 of the wireless server 2 transmits a response to the request. As a result, the DSC 1 detects existence of the wireless server 2, and the wireless server 2 also detects the presence of the DSC 1. Communication based on TCP/IP becomes feasible between the DSC 1 and the wireless server 2.

Upon detection of existence of the wireless server 2, the copy client. 74 of the DSC 1 becomes able to establish the communication based on TCP/IP. For this reason, the DSC 1 determines that the operation for connection with the wireless server 2 has been completed (step SI) and immediately (i.e., automatically) commences automatic saving operation without awaiting user's operation.

In addition to a determination based on decision of an IP address, the copy client 74 of the DSC 1 may determine that operation for connection with the wireless server 2 is completed on the basis of establishment of a connection through TCP.

When the operation for connection with the wireless server 2 has been completed, the copy client 74 of the DSC 1 and/or the copy server 64 of the wireless server 2 perform(s) automatic saving operation as initial processing of the direct printing operation. Specifically, for example, the copy client 74 of the DSC 1 transmits a connection request for determining whether or not the wireless server 2 can perform automatic saving by a method identical with the automatic saving performed by the DSC 1 (step S2). This connection request is described in the format of XML (extensible Markup Language) and handled as one text data file. Similarly, the request or response exchanged between the copy client 74 and the copy server 64 and that exchanged between the storage client 65 and the storage server 75 are described in XML.

The connection request generated by the copy client 74 of the DSC 1 is converted into communication data of TCP standards by the TCP driver 72 of the DSC 1, and the thus-converted communication data are further converted into communication data of IP standards by the TCP driver 72. The wireless communication circuit 13 of the DSC 1 transmits the communication data of IP standards to the wireless network 3. The destination of the communication data of the IP standards is an IP address of the preceding wireless server 2.

The wireless communication circuit 44 of the wireless server 2 connected to the wireless network 3 receives the communication data. The communication data received by the wireless communication circuit 44 are reversely converted into the communication data of TCP standards by the IP driver 51 of the wireless server 2, because the IP address of the destination of the received communication data is the IP address of the wireless communication circuit 44. Further, the thus-reversely-converted communication data are reversely converted into the connection request. The connection request generated through reverse conversion is passed to the copy server 64 from the TCP driver 62. As a result, the connection request is transmitted from the copy client 74 to the copy server 64.

The copy server 64 interprets specifics of the thus-reversely-converted connection request (step S3). As a result, the copy server 64 recognizes that a DSC 1 compatible with automatic saving is connected to the wireless server 2.

The copy server 64 generates a connection response which is described in an XML format and shows that automatic saving which is identical in method with that performed by the DSC 1 can be performed. The connection response generated by the copy server 64 of the wireless server 2 is converted into communication data of TCP standards by the TCP driver 62 of the wireless server 2. The communication data are further converted into communication data of IP standards by the IP driver 61. The thus-converted communication data are transmitted to the wireless communication circuit 13 of the DSC 1 from the wireless communication circuit 44 of the wireless server 2 by way of the wireless network 3, and the thus-transmitted communication data are reversely converted into communication data of TCP standards by the IP driver 71 of the DSC 1. The communication data are further reversely converted into the connection request by the TCP driver 72. The connection response generated through reverse conversion is passed to the copy client 74 from the TCP driver 72 of the DSC 1. As a result, the connection response is transmitted from the copy server 64 to the copy client 74 (step S4). Further, the copy client 74 interprets specifics of the thus-reversely-converted connection response and recognizes that the DSC 1 is connected to the wireless server 2 capable of performing automatic saving by a method identical with that performed by the copy client 74 (step S5).

When connecting operation is completed, the copy client 74 of the DSC 1 initiates functional information acquisition operation. Specifically, for instance, the copy client 74 of the DSC 1 generates a get function request described in XML format, and transmits the thus-generated get function request to the copy server 64 of the wireless server 2 (step S6). The copy server 64 interprets specifics of the get function request (step S7), and generates a get function response including information about storage capability of the copy server.

The information about storage capability of the copy server includes, e.g., version information compatible with the copy server 64, the name of a vendor, information unique to the vendor, the model name of the wireless server 2, a model, a serial number, and the like. In addition to these, the information about printing capability of the copy server includes storage capacity of the storage device 46, available storage capacity, and the type of a filing system of the storage device 46.

The copy server 64 of the wireless server 2 transmits the get function response to the copy client 74 of the DSC 1 (step S8). The copy client 74 of the DSC 1 interprets information about the storage capability of the wireless server 2 included in the get function response (step S9).

After completion of such an operation for acquiring functional information, the copy client 74 of the DSC 1 immediately and automatically generates a store request (storage command) for storing into the wireless server 2 the image data files 31 preserved in the removable memory 20, on the basis of the thus-interpreted storage capability of the wireless server 2 (step S10). Specifically, the copy client 74 generates a saving request for storing all of the image data files 31 which have never been automatically stored in the removable memory 20, by reference to the direct saving log data file 32.

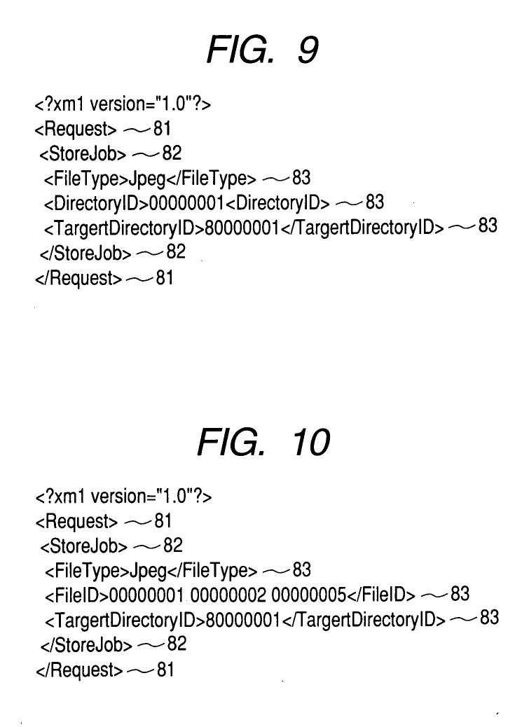

FIG. 9 is a view showing an example saving request generated by the copy client 74. The saving request is a request described in XML format and is handled as one text data file. A pair of tags 82 showing that the request pertains to a copy job (saving operation) are described between a pair of tags 81 showing the request. A pair of tags 83 whose attributes are represented by text data showing specifics of the storage command are described while being sandwiched between the pair of tags 82 showing a copy job.

The store request shown in FIG. 9 is an exemplary case where an image data file 31 of JPEG format, whose file ID is 00000001, in the directory (folder) is stored in the removable memory 20. In the store request shown in FIG. 9, the directory of the storage device 46 which is to serve as a storage area is specified as “80000001.” In the XML script for storage command shown in FIG. 9, a file format which is to become an object of saving operation is specified by a FileType tag. A directory (folder) of the removable memory 20 including a file, which is included in DSC1 and is to become an object of saving operation, is specified by a Directory ID tag. A directory (folder) of a storage area in the storage device 46 of the wireless server 2 is specified by a TargetDirectory ID tag.

The copy client 74 of the DPS 1 transmits the saving request to the copy server 64 of the wireless server 2 (step S11). The copy server 74 of the wireless server 2 interprets specifics of the storage command of the store request (step S12). The copy server 64 commands the storage client 65 to acquire the image data file 31 required for performing the saving operation (step S13). The storage client 65 generates a get image file request for acquiring the image data file 31 from the DSC 1 in connection with the image data file specified by the saving request (step S14). The get image file request is transmitted to the storage server 75 of the DSC 1 (step S15).

When the wireless server 2 has received the saving request shown in FIG. 9, the storage client 65 generates a get image file request for which a file ID of the directory specified by the DirectorylD tag is designated.

The storage server 75 of the DSC 1 commands the storage device 76 to transmit the image data file 31 required by the get image file request (step S16). The storage device 76 of the DSC 1 transmits to the wireless server 2 the image data file 31 instructed by the storage server 75 (step S17). When the DSC 1 has transmitted the saving request shown in FIG. 9 to the wireless server 2, the storage server 75 receives, from the wireless server 2, the get image file request which designates the file ID of the directory specified by the saving request. A command for transmitting the image data file 31 included in the directory is supplied to the storage device 76.

The image data file 31 is temporarily stored in the RAM 47 of the wireless server 2. Transfer of the image data file 31 is actually performed by exchanging communication data between the file transferer 73 of the DSC 1 and the file transferer 63 of the wireless server 2.

When the image data file 31 is stored in the RAM 47, the copy server 64 of the wireless server 2 instructs the saving processor 66 to perform saving operation (step S18). In accordance with the specifics of the saving request, the saving processor 66 outputs the image data file 31 stored in the memory 42 to the storage device 46 by-way of the I/O port 43. The storage device 46 stores the image data file 31 (step S19). When the wireless server 2 has received the saving request shown in FIG. 9, the saving processor 66 reads an image data file from the RAM 47, designates a directory specified by the TargetDirectoryID tag, and outputs the image data file to the storage device 46.

As a result, the image data file, which stores the same image data as the image data file 31 stored in the removable memory 20 of the DSC 1, is stored in the storage device 46 of the wireless server 2.

In the store request, when one or a plurality of image data files 31 in the removable memory 20 of the DSC 1 are specified directly, the copy client 74 of the DSC 1 generates a saving request for directly specifying the plurality of image data files 31. In an XML script of the saving request shown in FIG. 10, three files which are objects of saving operation and assigned file IDs are 00000001, 00000002, and 00000005 are specified by a FileID tag. When the saving request shown in FIG. 10 is transmitted from the DSC 1 to the wireless server 2, the get image file request specifying the file IDs is transmitted from the wireless server 2 to the DSC 1. The DSC 1 reads, from the removable memory 20, the image data files assigned the file IDs specified by the get image file request, and transmits the image data files to the wireless server 2.

However, as in the case of FIG. 10, when the saving is not started until acquisition of all of the plurality of image data files 31 is completed, a certain period of time is consumed before the saving processor 66 starts saving operation. The available storage capacity of the RAM 47 must be larger than the total quantity of data pertaining to all of the image data files 31. Consequently, when one image data file 31 is stored in the RAM 47, the saving processor 66 preferably sequentially performs saving operation. As a result, even when the time, which lapses before storage of the image data file 31 into the storage device 46 is completed, is shortened by curtailing the wait time of the saving processor 66 or when the available storage capacity of the RAM 47 is smaller than the total quantity of data pertaining to the image data files 31 stored in the removable memory 20, automatic saving operation can be performed.

After the thus-generated saving request has been sent to the print server (step S10), the copy client 74 adds, to the direct saving log data file 32, the file name (file ID) of the image data file 31 commanded to be stored by the saving request (step S20). As a result, automatic saving of the image data files 31 which are not commanded to be stored through the current automatic direct saving operation is not commanded through the next automatic direct saving operation. Specifically, the only image data files 31 that are stored during the next automatic saving operation are those that have been added to the removable memory 20 after the current saving operation.

For example, in one possible sequence of operations, the copy client 74 generates long unique identification information of, e.g., 64 digits or 128 digits, on the basis of the file name or data pertaining to the image data file 31 transmitted from the DSC 1 to the wireless server 2; the copy server 64 compares the identification information about the image data file 31 received by the wireless server 2 with the identification information registered in the database; and only the image data files 31 for which no coincident identification information is found in the database are stored in the saving processor 66.

As mentioned above, in the first embodiment, after the wireless server 2 and the DSC 1 are automatically connected together upon having become connectable, automatic saving is started. Consequently, the user does not have to perform operation for causing the DSC 1 or the wireless server 2 to perform saving operation. Consequently, the user is not required to perform complicated operation every time one of the image data files 31 of the DSC 1 is stored in the wireless server 2.

In the first embodiment, a saving request for saving all of the image data files 31 which have never been subjected to automatic saving is generated on the basis of the direct saving log data file 32. Therefore, a command for saving the image data files, which have already been stored in the wireless server 2, through use of the saving request is prevented. Consequently, storage of the same image data files 31 in the DSC 1 into the wireless server 2 a plurality of times is prevented.

In the first embodiment, the copy client 74 of the DSC 1 determines completion of the operation for connection with the wireless server 2, and storage is automatically initiated on the basis of the determination. However, the copy server 64 of the wireless server 2 may determine completion of the operation with the DSC 1 and request the DSC 1 to initiate saving operation, and the DSC 1 may automatically start saving operation in response to the request.

In the first embodiment, after the operation for connection with the wireless server 2 using a lower protocol such as the file transferer 73 has been completed, the copy client 74 of the DSC 1 initiates the automatic saving operation sequence. In this case, the point in time when the operation for connection with the wireless server 2 is completed may be taken as a point in time when the copy client 74 has completed connecting operation or operation for acquiring functional information.

In the first embodiment, only the image data files 31 that have never been subjected to automatic direct saving can be automatically stored in the wireless server 2. As a result, storage of the same image data file 31 in the wireless server 2 a plurality of times can be prevented.

In the first embodiment, the direct saving log data file 32 is stored in the removable memory 20 of the DSC 1. However, the direct saving log data file 32 may also be stored in the flash memory 12 of the DSC 1.

In the first embodiment, for each image data file 31 that has ever been directly stored, the file name or file ID is stored in the direct saving log data file 32. However, in addition to the file name or file ID, a creation time of the file, EXIF data pertaining to the file, or a hash value of the image data or the file (entire data) may also be stored along with the file name or file ID. As a result of storage of the plurality of pieces of information about the respective image data files 31 that have ever been stored, the stored image data files 31 and the image data files 31 that have not yet been stored can be accurately determined on the basis of the information about the plurality of files or a combination of the pieces of information. An accurate determination can be made as to whether or not the respective image data files 31 are to be automatically stored. Consequently, even when the plurality of image data files 31 having the same file name are present, these data files can be automatically stored.

In the first embodiment, the direct saving log data are stored in the DSC 1, and the copy client 74 of the DSC 1 generates a saving request for instructing save of the image data files 31 which are not stored in the log. In addition, it may also be possible that the direct saving log data are stored in the wireless server 2 and that the copy server 64 of the wireless server 2 stores into the storage device 46 the image data files 31 except for those image data files 31 included in the direct saving log data.

In the first embodiment, a log (saving log) pertaining to direct saving is recorded on the direct saving log data file 32. In addition, for example, the log pertaining to direct saving (saving log) may be recorded in a part of the image data file 31 or another file.

An automatic storing system according to a second embodiment of the present invention has the DSC 1 and the wireless server 2 additionally imparted with functions to be described later. The DSC 1 and the wireless server 2 are connected together by the wireless network 3. The hardware configuration of the wireless server 2, that of the DSC 1, and that of the wireless network 3 exhibit the same functions as do the counterpart elements given the same names in the automatic storing system of the first embodiment; the same reference numerals and designations as those employed in the first embodiment; and their illustrations and explanations are omitted.

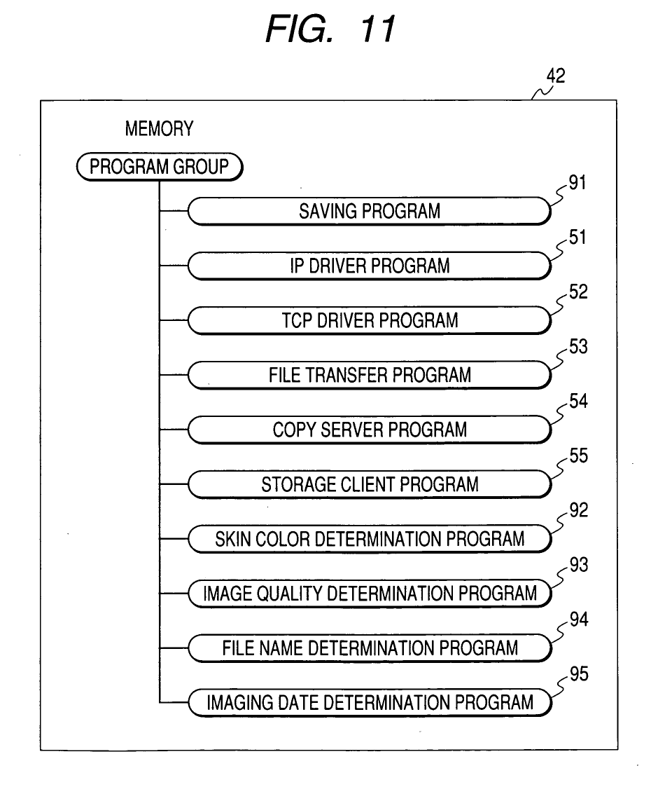

FIG. 11 is a view showing stored contents of the memory 42 of the wireless server 2 in an automatic storing system according to a second embodiment of the present invention. A program group is stored in the memory 42 of the wireless server 2. The program group of the memory 42 includes a saving program 91, the IP driver program 51, the TCP driver program 52, the file transfer program 53, the copy server program 54, the storage client program 55, a skin color determination program 92, an image quality determination program 93, a file name determination program 94, and an imaging date determination program 95.

The saving program 91 is executed by the CPU 41, thereby realizing a saver. The saver determines image data files stored in the RAM 47, classifies the image data files in accordance with the result of determination, and stores the thus-classified image data files into the storage device 46.

The skin color determination program 92 is executed by the CPU 41, thereby realizing a skin color determinant. The skin color determinant determines whether or not the image is an image of one or more persons (hereinafter called a “human image”, according to the proportion of skin color in the image included in the image data file. Specifically, the type of the subject of the image is determined. More specifically, for instance, when the proportion of skin color pixels to the total number of pixels forming the image is 5% or more, the skin color determinant determines the image is a human image. When the proportion of skin color pixels is 5% or less, the image is determined not to be a human image.

The image quality determination program 93 is executed by the CPU 41, thereby realizing an image quality determinant. The image quality determinant determines whether or not the image is a blurred image, on the basis of a mean edge value of the image included in the image data file. More specifically, for instance, the image quality determinant subjects an image to edge processing to extract a maximum edge value for each predetermined area, and computes a mean value of the maximum edge values. When the mean value of the maximum edge values is equal to a predetermined threshold value or less, the image quality determinant determines the image to be a blurred image. Conversely, when the mean value of the maximum edge values is greater than the predetermined threshold value, an image quality determinant 103 determines the image to not be a blurred image. The image quality determinant may compare the mean value weighted on a per-area basis with the mean edge value of the image rather than comparing the mean value of the maximum edge values in each predetermined area with the threshold value serving as the mean edge value of the image.

The file name determination program 94 is executed by the CPU 41, thereby realizing a file name determinant. When a file name is created pursuant to a DCF (Design rule for Camera File system), the file name determinant determines whether the image is a panoramic image, one of successively captured images, or another type of image, on the basis of the file name.

The imaging date determination program 95 is executed by the CPU 41, thereby realizing an imaging date determinant. The imaging date determinant acquires imaging date information included in the image data file, and outputs the imaging date information.

Programs of the wireless server 2 other than the above-mentioned programs exhibit the same functions as do the programs given the same names in the first embodiment; the same reference numerals are assigned to these programs; and their explanations are omitted.

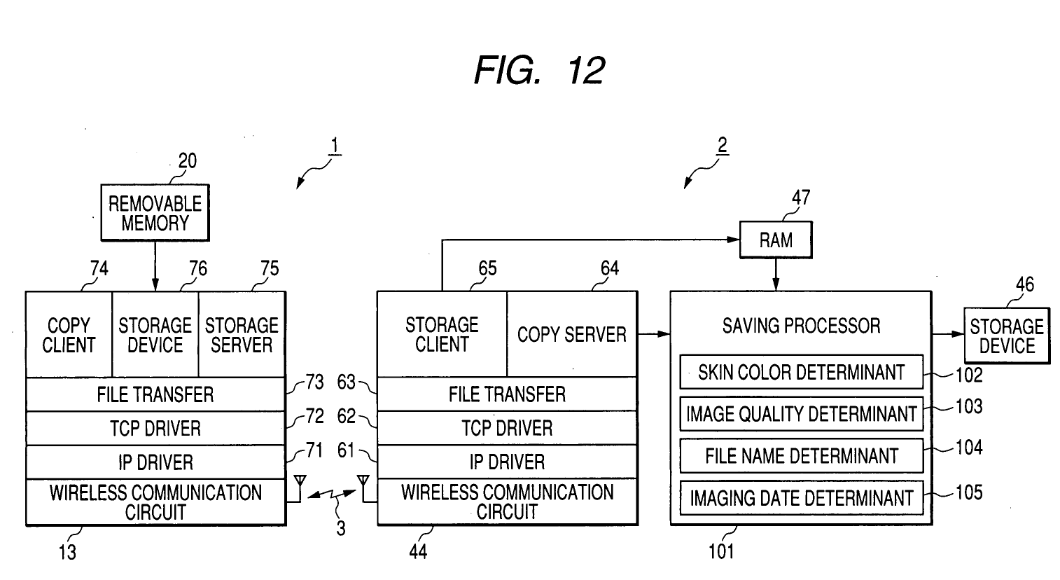

Operation of the automatic storing system having the above-described configuration will now be described. FIG. 12 is a view showing the stacked structure of a communication protocol for use in automatic saving operation realized by the automatic storing system of the second embodiment. In the second embodiment, the wireless server 2 realizes a saving processor 101 which is to serve as a saver, a skin color determinant 102, an image quality determinant 103, a file name determinant 104, and an imaging date determinant 105.

As in the case of the first embodiment, when the DSC 1 and the wireless server 2 are present within each other's wireless connection zones, the IP address of the DSC 1 and that of the wireless server 2 are determined. Upon detection of presence of the wireless server 2, the copy client 74 of the DSC 1 determines that the operation for connection with the wireless server 2 has been completed, and initiates automatic saving operation. During the automatic saving operation, the copy client 74 of the DSC 1 and the copy server 64 of the wireless server 2 perform connecting operation (steps SI to S5) and function information acquisition operation (steps S6 to S9). Subsequently, the copy client 74 transmits the saving request to the copy server 64 (steps S10, S11), and a get image file request is transmitted from the storage client 65 of the wireless server 2 to the storage server 75 of the DSC 1 (steps S12 to S16). The image data file 31 newly recorded in the removable memory 20 is transferred from the DSC 1 to the wireless server 2 (step S17). The image data file is stored in the memory 42 of the wireless server 2.

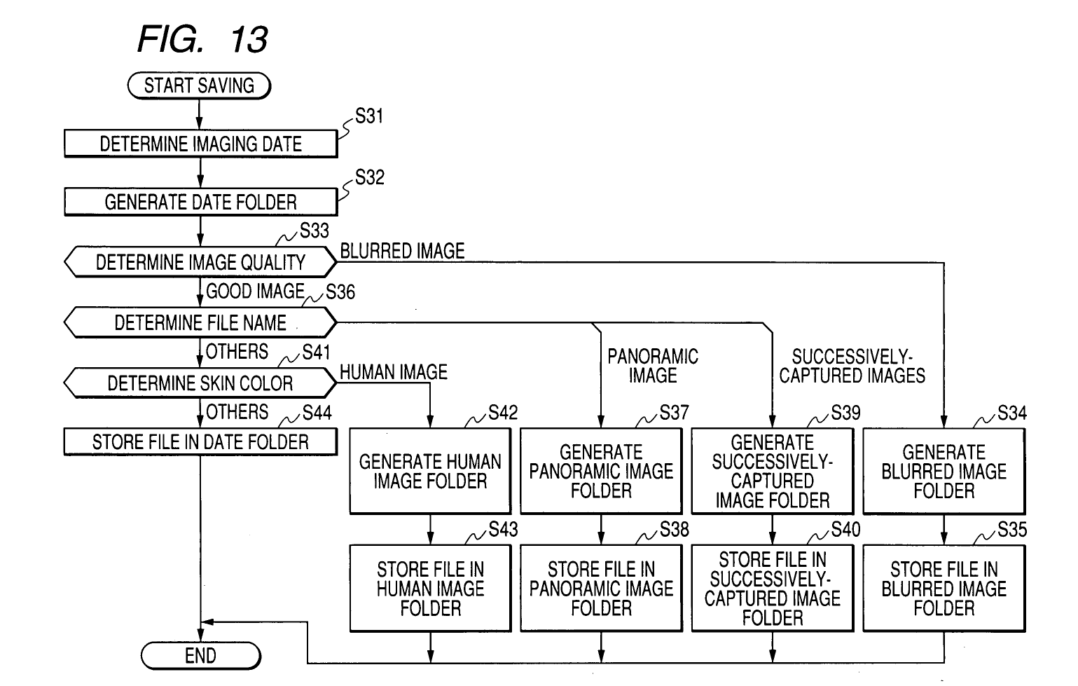

After the memory 42 has acquired the image data file, the copy server 64 of the wireless server 2 commands the saving processor 101 to perform saving operation (step S18). The saving processor 101 classifies the image data files through use of the skin color determinant 102, the image quality determinant 103, the file name determinant 104, and the imaging date determinant 105, and performs saving operation (step S19). FIG. 13 is a flowchart showing example saving operation of the saving processor 101 of the second embodiment.

The saving processor 101 causes the imaging date determinant 105 to determine a date (step S31). The imaging date determinant 105 retrieves the image data file acquired from the DSC 1 and stored in the RAM 47, and outputs imaged date-and-time information included in appendix information of the image data file. The saving processor 101 causes the storage device 46 to generate a date folder whose folder name is a date indicated by the imaged date-and-time information (step S32). When a date folder having the same name has already been generated by the storage device 46, the saving processor 101 does not newly generate a date folder.

Next, the saving processor 101 performs operation for determining the type of an image (step S33). Specifically, the saving processor 101 first causes the image quality determinant 103 to determine whether an image is defective or nondefective. The image quality determinant 103 determines whether the image of the image data file 31 stored in the RAM 47 is defective or nondefective, and outputs the result of determination. When the result of determination of the image is defective, the saving processor 101 generates a folder with a predetermined folder name showing a blurred image within the previously-generated date folder (step S34), and stores the image data file stored in the RAM 47 into the thus-generated blurred image folder (step S35). When a blurred image folder of the same name has already been generated by the storage device 46, the saving processor 101 does not generate the blurred image folder. When the file having the same name as that of the image data file which is about to be stored is present in the blurred image folder, the saving processor 101 changes the file name of the image data file which is about to be stored, and stores the image data file into the blurred image folder. After storage of the image data file, the operation for storing the file is completed.

When the result of determination made by the image quality determinant 103 shows that the image is nondefective, the saving processor 101 successively causes the file name determinant 104 to determine the type of an image (step S36). The file name determinant 104 determines whether the image is a panoramic image, one of successively-captured images, or another type of image, on the basis of the file name of the image data file stored in the RAM 47. When the image is determined to be a panoramic image, the saving processor 101 generates a folder with a predetermined folder name showing a panoramic image within the previously-generated date folder (step S37). The image data file stored in the RAM 47 is stored in the thus-generated panoramic image folder (step S38). When the image is determined to be one of successively-captured images, the saving processor 101 generates a folder with a predetermined folder name showing a successively-captured images within the previously-generated date folder (step S39). The image data file stored in the RAM 47 is stored in the thus-generated successively-captured images folder (step S40). When a panoramic image or successively-captured images folder of the same name has already been generated by the storage device 46, the saving processor 101 does not generate that folder. When a file having the same name as that of the image data file which is about to be stored is present in the panoramic image or successively-captured images folder, the saving processor 101 changes the file name of the image data file which is about to be stored, and stores the image data file into the panoramic image or successively-captured images folder. After storage of the image data file, the operation for storing the file is completed.

When the image is neither a panoramic image nor one of successively-captured images, the saving processor 101 successively causes the skin color determinant 102 to determine the type of the image (step S41). The skin color determinant 102 analyzes the image of the image data file stored in the RAM 47, thereby determining whether or not the image is a human image. When the image is determined to be a human image, the saving processor 101 generates a folder with a predetermined folder name showing a human image within the date folder (step S42), and stores the image data file stored in the RAM 47 into the thus-generated human image folder (step S43). When a human image folder of the same name has already been generated by the storage device 46, the saving processor 101 does not generate that human image folder. When a file having the same name as that of the image data file which is about to be stored is present within the human image folder, the saving processor 101 changes the file name of the image data file which is about to be stored, and stores the file in the human image folder. After storage of the file, the operation for storing the file is completed.

When the image is determined not to be a human image, the saving processor 101 stores the image data file stored in the RAM 47 into the date folder (step S44). The saving processor 101 may generate a folder having a predetermined folder name within the date folder and store into the thus-generated folder the image data file stored in the RAM 47. After storage of the file, the operation for storing the file is completed.

As mentioned above, in the second embodiment, the type of an image data file which is to be stored in the wireless server 2 is automatically determined, and the image data file is stored in the storage device 46 while being automatically classified on a per-folder basis according to the result of determination. Therefore, the user can narrow the image data files 31 on the basis of recollection of the imaged date, thereby efficiently retrieving an image of a target image data file 31.

Therefore, even when the image data file 31 stored in the removable memory 20 is automatically stored in the storage device 46 of the wireless server 2; particularly when the number of image data files stored in the wireless server 2 has become enormous in association with an increase in frequency of utilization of the DSC 1 or an increase in storage capacity of the removable memory 20, an image of a target image file 31 can be efficiently retrieved without involvement of operation for ascertaining the images of the image data files 31 stored in the storage device 41 by opening the files one by one. Consequently, despite not having performed saving operation by himself/herself, the user can efficiently find a target image data file from among a plurality of image data files stored in the wireless server 2, in accordance with classification of the folders.

In the second embodiment, the image data files are classified on a per-imaged date basis, and the storage device 46 stores the images after having further classified the images into the blurred image, the panoramic image, one of the successively-captured images, the human image, and other images. In addition, it may also be possible that the image data files are stored in the storage device 46 after having been classified according to any one of a plurality of criteria, such as an imaged date criterion, a blurred image criterion, a panoramic image criterion, a continuous-image criterion, and a subject type criterion. The image data file 31 may also be determined and classified according to a recording mode determination, such as a monochromatic image or a color image.

In the second embodiment, the image data file 31 recorded in the removable memory 20 is classified through use of folders. In addition, the image data files 31 may also be classified by changing the file names of the image data files to character strings which differ in accordance with the type of an image and show the type of the image.

An automatic storing system according to a third embodiment of the present invention has the DSC 1 and the wireless server 2 having additional functions to be described later. The DSC 1 and the wireless server 2 are connected together by the wireless network 3. Further, the hardware configuration of the wireless server 2, that of the DSC 1, and that of the wireless network 3 are the same as those of the counterpart wireless server 2, the counterpart DSC 1, and the counterpart wireless network 3 in the first embodiment. The same designations and reference symbols are used, and their illustrations and explanations are omitted.

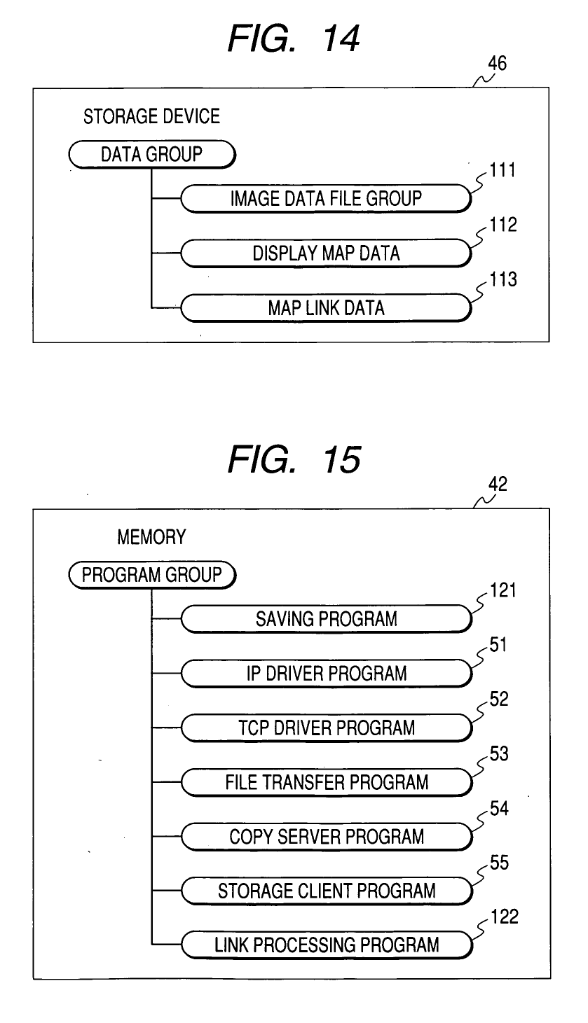

FIG. 14 is a view showing stored contents of the storage device 46 of the wireless server 2 in an automatic storing system according to the third embodiment of the present invention. A data group is stored in the storage device 46. The data group of the storage device 46 includes an image data file group 111, display map data 112, and map link data 113.

The image data file group 111 is formed from a plurality of image data files 31.

The display map data 112 has map display image data and longitude/latitude data pertaining to respective points on the map.

The map link data 113 includes, in an associated manner, information about the location of the storage device 46 where the image data file 31 is stored (i.e., path information) and the longitude and latitude of a location where the image of the image data file 31 was captured.

FIG. 15 is a view showing stored contents of the memory 42 of the wireless server 2 in the automatic storing system of the third embodiment of the present invention. A program group is stored in the memory 42 of the wireless server 2. The program group of the memory 42 includes a saving program 121, the IP driver program 51, the TCP driver program 52, the file transfer program 53, the copy server program 54, the storage client program 55, and a link processing program 122. The programs of the wireless server 2 other than the saving program 121 and the link processing program 122 exhibit the same functions as do the programs assigned the same names in the first embodiment; the same reference numerals are assigned to these programs; and their explanations are omitted.

The saving program 121 is executed by the CPU 41, thereby realizing a saver. The saver stores into the storage device 46 the image data file 31 which has been acquired from the DSC 1 and stored in the RAM 47.

The link processing program 122 is executed by the CPU 41, thereby realizing a link processor. The link processor updates the map link data 113.

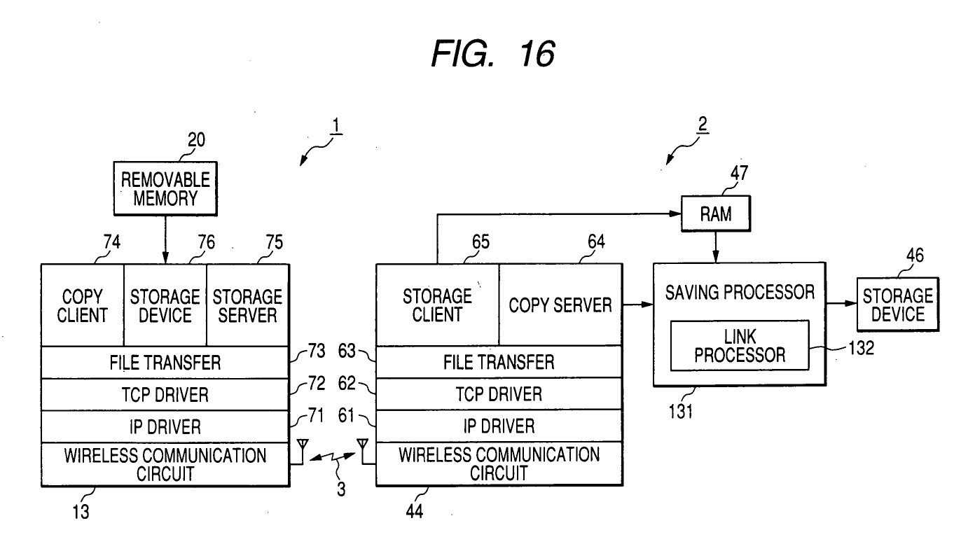

Operation of the automatic storing system having the above-described configuration will now be described. FIG. 16 is a view showing the stacked structure of a communication protocol for use in automatic saving operation realized by the automatic storing system of the third embodiment. In the wireless server 2 of the present embodiment, a saving processor 131 which is to serve as a saver and a link processor 132 are realized.

As in the case of the first embodiment, when the DSC 1 and the wireless server 2 are present within each other's wireless connection zones, the IP address of the DSC 1 and that of the wireless server 2 are determined. Upon detection of presence of the wireless server 2, the copy client 74 of the DSC 1 determines that the operation for connection with the wireless server 2 has been completed, and initiates automatic saving operation. During the automatic saving operation, the copy client 74 of the DSC 1 and the copy server 64 of the wireless server 2 perform connecting operation (steps SI to S5) and function information acquiring operation (steps S6 to S9). Subsequently, the copy client 74 transmits the saving request to the copy server 64 (steps S10, S11), and a get image file request is transmitted from the storage client 65 of the wireless server 2 to the storage server 75 of the DSC 1 (steps S12 to S16). The image data file 31 newly recorded in the removable memory 20 is transferred from the DSC 1 to the wireless server 2 (step S17). The image data file is stored in the memory 42 of the wireless server 2.

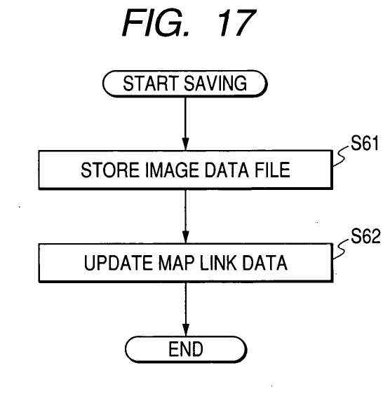

After the memory 42 has acquired the image data file 31, the copy server 64 of the wireless server 2 instructs the saving processor 131 to perform saving operation (step S18). The saving processor 131 associates the image data file with the display map data through use of the link processor 132, and performs saving operation (step S19). FIG. 17 is a flowchart showing example saving operation of the saver 132 of the third embodiment.

The saving processor 131 stores the image data file which has been acquired from the DSC 1 and stored in the RAM 47 into the storage device 46 as one image data file in the image data file group 111 (step S61).

The saving processor 131 causes the link processor 132 to perform link operation (step S62). The link processor 132 retrieves positional information showing the location where an image was captured, such as GPS (Global Positioning System) information, from the appendix information about the previous image data file newly stored in the storage device 46. When the positional information has been extracted, the link processor 132 associates the longitude and latitude values of the imaged position with the location where the image data file is stored, and adds the information to the map link data 113. Specifically, information about the longitude and the latitude achieved when the image was captured is acquired by a GPS receiver of the DSC 1, and the longitude and latitude information is included in the image data file of the DSC 1 as appendix information.

As mentioned above, in the third embodiment, the image data file 31 stored in the removable memory 20 of the DSC 1 is stored in the storage device 46 of the wireless server 2. Information about the location where the image data file was acquired and the location in the storage device 46 where the image data file is stored are stored in the map link data 113 in an associated manner.

Therefore, the wireless server 2 of the third embodiment displays, on an unillustrated display device, a map image based on the display image data. On the basis of the map link data 113, the image of the image data file can be displayed in a superimposed manner at a position on the displayed map determined by the longitude and latitude of the location where the image was captured. From the images displayed on the map on the basis of recollections of the locations where the images were captured, the user can efficiently retrieve the image of the target image data file. In this case, when the size of the image of the image data file is large, the image is displayed after having been scaled down.

Therefore, even when the image data file 31 stored in the removable memory 20 is automatically stored in the storage device 46 of the wireless server 2; particularly when the number of image data files stored in the wireless server 2 has become enormous in association with an increase in frequency of utilization of the DSC 1 or an increase in storage capacity of the removable memory 20, an image of a target image file 31 can be efficiently retrieved without involvement of operation for ascertaining the images of the image data files 31 stored in the storage device 46 by opening the files one by one. Consequently, despite not having performed saving operation by himself/herself, the user can efficiently find a target image data file from among a plurality of image data files stored in the wireless server 2 by reference to the map link data 113.

In the third embodiment, the longitude and latitude values of the location where the image of the image data file 31 was captured are stored in the map link data 113 in association with the information about the location in the storage device 46 where the image data file 31 is stored. In addition, it may also be possible that the address of the location where the image was captured or a feature has previously been recorded in the image data file 31 in place of the longitude and latitude values; and that the information is stored in association with the address or feature.

The above-described embodiment is an example of the preferred embodiment of the present invention. However, the present invention is not limited to the embodiment, and is susceptible to various modifications or alterations.

In the respective embodiments, the DSC 1 is connected to the wireless server 2 by way of the wireless network 3. In addition, the DSC 1 may also be connected to a wireless server capable of automatically storing an image data file by way of a wired network using a cable.

In the respective embodiments, the DSC 1 or the wireless server 2 automatically performs operation for storing the image data file 31 upon detection of connection with the counterpart device. In addition, when connection between the DSC 1 and the wireless server 2 has been detected, an inquiry is made as to whether or not the display device 18 of the DSC 1 performs automatic saving operation. In accordance with the result of the inquiry, operation for storing the image data file 31 may also be performed on the basis of the automatic saving command input by way of the input device 19.

In the respective embodiments, the image storing apparatus is embodied as a server. In lieu of the server, the image storing apparatus may be embodied as a display device having a recording medium or a printing device.

In the respective embodiments, the image supplying apparatus is embodied as a digital still camera. In lieu of the digital still camera, the image supplying apparatus may be embodied as a portable cellular phone having an imaging function, a PDA (Personal Digital Assistant), a personal computer, or the like.

1. An image supplying apparatus, comprising:
a communicator;
a monitor, which monitors whether or not an image output apparatus adapted to receive an image data file and to store the image data file is communicable with the communicator;
a communication connector, which connects the communicator to the image storing apparatus when the monitor determines that the communicator is communicable with the communicator; and
a saving instructor, which causes the image storing apparatus to initiate saving operation of the image data file immediately after the communicator is connected to the image storing apparatus.

2. The image supplying apparatus as set forth in claim 1, wherein the saving instructor causes the image storing apparatus to store only image data files having no saving log, as determined on the basis of a log pertaining to storage of an image data file into the image storing apparatus.

3. an image storing apparatus comprising:
a communicator;
an acquirer, which acquires an image data file from an image supplying apparatus by way of the communicator immediately after the image supplying apparatus adapted to transmit an image data file has become communicable with the communicator;
a storage; and
a saver for saving the acquired image data file into the storage.

4. The image storing apparatus as set forth in claim 3, wherein the saver saves the acquired image data files into the storage after having classified the files according to the type of an image.

5. The image storing apparatus as set forth in claim 4, wherein the saver determines the type of an image of the acquired image data file on the basis of at least one of a criterion for determining an imaging date, a criterion for determining that an image is blurred, a criterion for determining that an image is a panoramic image, a criterion for determining an image is one of successively-captured images, a criterion for determining the type of a subject, and a criterion for determining a recording mode.

6. The image storing apparatus as set forth in claim 4, wherein the saver saves the acquired image data file into a different folder of the storage according to a determination result of the type of the image.

7. The image storing apparatus as set forth in claim 3, wherein after having saved the acquired image data file into the storage, the saver saves in the storage map link data which associate information about a location of the storage where the image data file is stored with information about a location where an image of the image data file has been captured.

8. An automatic storing system, comprising the image supplying apparatus as set forth in claim 1 and the image storing apparatus as set forth in claim 3.

9. An image storing method, comprising:
monitoring whether or not an image supplying apparatus adapted to output an image data file is communicable with an image storing apparatus adapted to receive and store the image data file;
connecting the image supplying apparatus to the image storing apparatus when the image supplying apparatus and the image storing apparatus become communicable with each other; and
transmitting the image data file from the image supplying apparatus to the image storing apparatus immediately after the connection between the image supplying apparatus and the image storing apparatus is established, in order to save the image data file in the image storing apparatus.
